(19) United States
(12) Patent Application Publication
(10) Pub. No.: US 2009/0095583 A1
(43) Pub. Date: Apr. 16, 2009

(54) Heat sink for disc brake rotor

(76) Inventor: Henry Dudley, Toms River, NJ (US)

Correspondence Address: CLIFFORD G. FRAYNE, 136 DRUM POINT RD, SUITE 7A, BRICK, NJ, 08723, US

(21) Appl. No.: 12/283,570

(22) Filed: Sep. 15, 2008

Related U.S. Application Data
(60) Provisional application No. 60/998,903, filed on Oct. 15, 2007.

(51) Int. Cl. B62L 5/06

(52) U.S. Cl. 188/218 XL

(57) ABSTRACT

A disc brake rotor element for a vehicle braking system, the disc brake rotor having a plurality of heat sinks positioned in the surface area contacted by the disc brake shoes in order to aid in the dissipation of heat from the brake rotor, thus maintaining the brake rotor at a cooler temperature which improves the efficacy of the braking system.

### RELATED APPLICATIONS

Applicant claims the benefit of provisional application Ser. No. 60/998,903, filed Oct. 15, 2007.

### BACKGROUND OF THE INVENTION

1. Field of the Invention

The present invention relates to brakes, and in particular, disc brake rotors, which incorporate a plurality of individual heat sinks which improve the cooling of the disc brake rotor and the prevention of overheating.

2. Description of the Prior Art

Motor vehicle brakes have become more sophisticated as motor vehicles have developed. This sophistication has been driven by the fact that motor vehicles are increasingly faster than when first introduced, and that safety concerns are a high priority, not only for the manufacturer of the vehicle, but also for the purchaser of the vehicle, either for regular home owner vehicles or racing vehicles.

Motor vehicle brakes have evolved from the drum brake in which a drum member rotated with the wheel and force was applied to the inner circumference of the drum by arcuate pads which were pneumatically operated via the brake pedal to push outwardly against the arcuate inner surface of the brake drum in order to slow and stop the vehicle.

The drum brake eventually evolved into a disc brake which had better stopping characteristics than the drum brake and which would become a standard feature on most vehicles with respect to the front brakes, although many vehicles are equipped with four wheel disc brakes. The concept of the disc brake is a circular rotor which rotates on the axle with the wheel, the annular outer contact surface of the rotor passing between a pair of opposing brake shoes which are pneumatically activated to press against the rotating rotor by application of the brake pedal in order to slow or stop the rotor and the vehicle.

The enemy of all brake mechanisms is heat. The mechanism utilized to slow or stop a vehicle in both the drum brake and the disc brake is friction, and that friction generates elevated temperatures of the brake elements which will affect their performance, particularly when brakes are repeatedly applied. This can occur in a passenger vehicle traversing a downhill curving road, which would require constant reapplication of the brakes to slow down or in racing situations wherein a race car must brake from relatively high speeds in order to traverse a curve or turn and must repeatedly perform this function.

The heat problem was first addressed with respect to disc brakes by forming the disc brake with the two spaced apart rotors having radial arms positioned there between. In this configuration, a disc brake shoe contacts one of the rotating rotors and the opposing disc brake shoe contacts the spaced apart rotating rotor. The heat generated in slowing or stopping the vehicle remains the same as if both disc brake shoes were contacting the same rotor, but in this design, the heat is divided between two separate rotating rotors. The radial arms sandwich between the disc brake rotors serve to increase surface area to dissipate heat and to generate air flow turbulence which aids in the cooling of the brake mechanism elements.

The disc brake rotor in most common usage is fabricated from metal, such as steel, metal matrix, ceramic, carbon, carbon fiber, or combinations thereof, due to fabrication costs and availability of material. More exotic racing cars have addressed the heat issue of brakes by looking to alternative materials such as carbon or carbon fiber rotors. These carbon fiber disc rotors perform very well on race cars in that they remain stable at significantly high temperatures and are able to cool rapidly upon release of the brake mechanism. Unfortunately the cost of material and fabrication time make these carbon fiber rotors prohibitive with respect to use on your normal family car.

There therefore has been a need for a disc brake rotor which was capable of dissipating heat without affecting the performance of the brake mechanism and which could be massed produced without any significant increase in cost.

### OBJECTS OF THE INVENTION

An object of the present invention is to provide for a novel disc brake rotor which incorporates a plurality of heat sinks which prevents the overheating of the rotor.

A still further object of the present invention is to provide for a novel disc brake rotor which incorporates a plurality of heat sinks which allow the rotor to cool faster and which extends the life expectancy of the disc brake rotor.

A still further object of the present invention is to provide for a novel disc brake rotor which incorporates a plurality of heat sinks, each of the heat sinks maximizing its surface area in order to dissipate heat.

A still further object of the present invention is to provide for a novel disc brake rotor incorporating a plurality of heat sinks, which heat sinks can be easily positioned in the outer annular portion of the disc brake rotor.

### SUMMARY OF THE INVENTION

A disc brake rotor element for a vehicle braking system, the disc brake rotor having a plurality of heat sinks positioned in the surface area contacted by the disc brake shoes in order to aid in the dissipation of heat from the brake rotor, thus maintaining the brake rotor at a cooler temperature which improves the efficacy of the braking system.

### BRIEF DESCRIPTION OF THE DRAWINGS

These and other objects of the present invention will become apparent, particularly when taken in light of the following illustrations wherein:

FIG. 1 is a plan front view of a first embodiment of a disc brake rotor of the present invention;

FIG. 2 is an exploded end view of a disc brake rotor of the present invention;

FIG. 3 is an enlarged perspective view of the heat sink element incorporated into the disc brake rotor;

FIG. 4 is a front plan view of a second embodiment of a disc brake rotor of the present invention;

FIG. 5 is an exploded view of a disc brake rotor of the present invention; and

FIG. 6 is a perspective view of a second embodiment of a heat sink for a disc rotor.

### DETAILED DESCRIPTION OF THE INVENTION

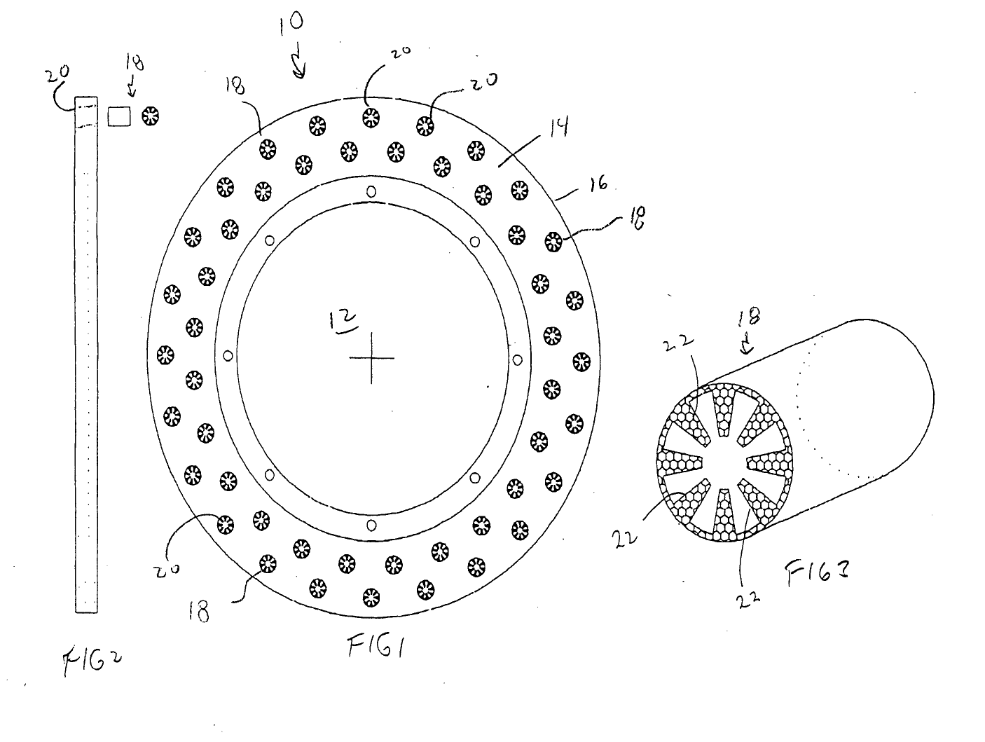

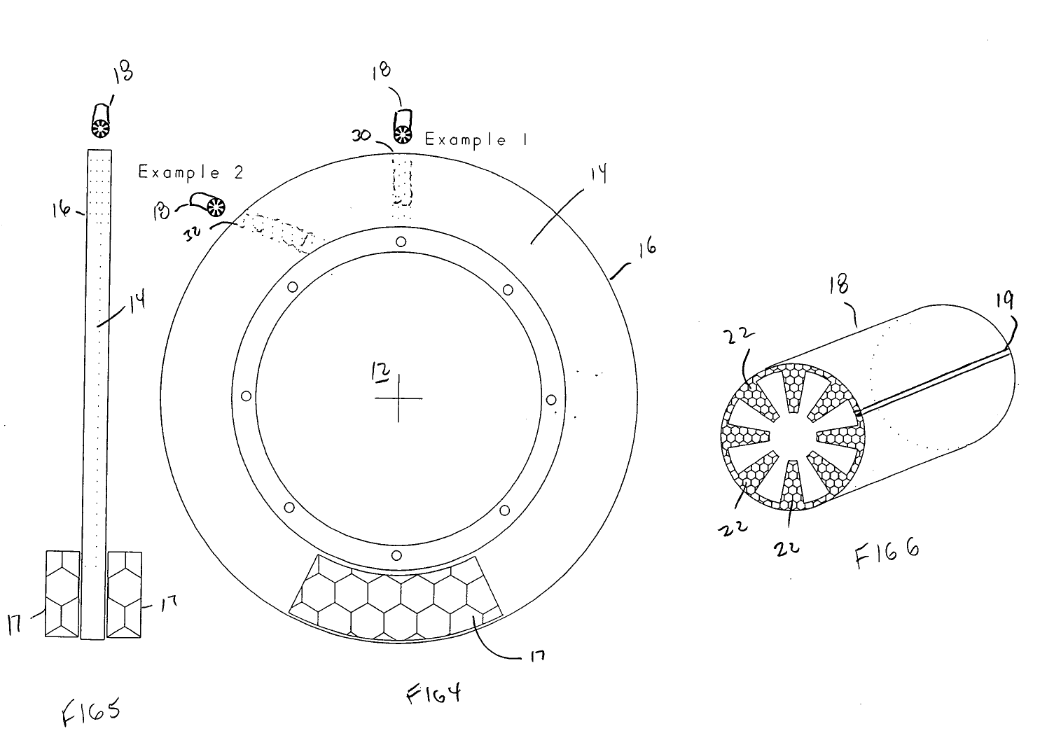

FIG. 1 is a front plan view of a disc brake rotor 10 of the present invention. The disc brake rotor 10 has a central hub portion 12 for mounting the disc brake rotor and it has an annular surface contact area 14 defined as the annular area between the hub portion 12 and the outer circumferential wall 16 of the rotor 10. This annular surface contact area 14 spins within a brake shoe 17 (see FIGS. 4 and 5) having a pneumatically actuated contact surface which will frictionally engage the annular surface contact area 14 of spinning disc rotor 10 in order to reduce or completely stop its revolutions.

In accordance with Applicant's invention, there would be a plurality of heat sinks 18 embedded in preformed apertures 20 in the annular contact surface area 14. It will be recognized by one of ordinary skill in the art that these preformed apertures 20 and the attendant heat sinks 18 which are positioned therein and pressed in position, must be positioned in order to balance the rotation of the disc brake rotor 10. In the instant FIG. 1, for purposes of explanation, the disc brake rotor 10 is fitted with 48 heat sinks 18. It should be noted that there can be more or less of such heat sinks depending upon the size of the rotor 10 and the area of the annular contact surface 14. The heat sink is illustrated in FIG. 3 and is tubularly cylindrical in shape having a plurality of inwardly depending fins 22. Fins 22 are spaced apart from each other and are radially positioned, but do not contact each other or extend to the axis of the tubular cylindrical heat sink.

FIG. 2 is an end exploded view illustrating the cross section of the heat sink 18 and the heat sink prior to its being positioned within the annular surface contact area 14 of the disc brake rotor 10 and pressed into position.

In this design, the plurality of heat sinks 18 provide a larger surface area for cooling of the disk brake rotor 10 by the air stream flowing past it. The heat sink material should be a close thermal expansion match to the rotor material in order to expand and contract complimentary with the rotor. Alternatively, the heat sink 18 could be provided with a slit 19 along its outer perimeter and either pressed or brazed into the aperture 20 formed in the rotor 10 (See FIG. 6).

As an example, a cast iron rotor has a coefficient of thermal expansion of 11.8 ppm/C at 20 degrees C., and a steel heat sink 18 of the type described would have a coefficient of thermal expansion of approximately the same.

Conversely, a titanium rotor has a coefficient of thermal expansion of 8.6 ppm/C at 20 degrees C. To match a titanium rotor, a metal matrix material may have to be used of the type known as THERMKON 83, a trademark product of CMW, Inc. of Indianapolis, Ind., which has a coefficient of thermal expansion of 8.5 ppm/C at 20 degrees C.

The heat sink material could be fabricated from metal, metal matrix, ceramic, carbon, carbon fiber, or combinations thereof, depending upon the rotor material, the coefficient of thermal expansion and the necessity of matching the coefficient of thermal expansion.

In FIGS. 1, 2, and 3, the heat sink 18 has been positioned, pressed or brazed into the annular contact surface area 14 of the disc brake rotor 10 such that the axel of the heat sink 18 is parallel to the axel of the rotor.

In an alternative embodiment as illustrated in FIGS. 4 and 5, a heat sink of the same design 18 could be positioned into the circumferential edge 16 of the disc rotor 10 either radially 30 as illustrated in example 1 of FIG. 4, or obliquely 32 as illustrated in Example 2 of FIG. 4. In each of the instances in FIG. 4, the heat sink 18 again serves to provide more surface area in order to dissipate the heat. With respect to the embodiment illustrated in FIG. 4, consideration must again be given to the positioning of the heat sinks 18 about the peripheral edge 16 of the disc rotor 10 in order to maintain the balance of the disc rotor and not disrupt its plane of rotation such as to cause wobble and inadvertent contact with the brake shoe.

While the heat sink 18 is illustrated in FIGS. 1, 2, and 3, which is positioned transversely to the annular contact surface area 14 of disc rotor 10, and therefore is limited in its size by the thickness of the disc rotor, the heat sink 18 is illustrated in FIGS. 4 and 5 is limited in its diameter by the thickness of the brake rotor 10, but its length may be greater than that of the heat sink 18 illustrated in FIGS. 1, 2, and 3 depending upon the width of the annular contact area of the disc rotor.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. An improved disc brake for improving heat dissipation and cooling, said improved disc brake comprising:
a rotatable disc brake rotor having a centrally positioned hub for mounting; said disc brake rotor having an annular contact surface area about said hub, said annular contact surface area having a first side and a second side, and a circumferential periphery, said annular contact surface area rotatable within a brake shoe, said brake shoe pneumatically actuated to frictionally engage said annular contact surface area to slow or stop said rotation of disc brake rotor, said annual contact surface area formed with a plurality of bores for receipt of a plurality of heat sinks engaged in said bores, each of said plurality of heat sinks being tubular in design having a plurality of inwardly depending radial fins in spaced apart relationship for increased surface area of said annular contact surface area for heat dissipation and cooling.

2. The improved disc brake in accordance with claim 1 wherein said plurality of bores for receipt of said plurality of heat sinks are formed between said first surface and said second surface of said disc brake rotor on said annular contact surface area.

3. The improved disc brake in accordance with claim 1 wherein said plurality of bores for receipt of a plurality of heat sinks are formed in the circumferential periphery of said disc brake rotor in either axial or oblique relationship to said hub of said rotor.

4. The improved disc brake in accordance with claim 1 wherein said coefficient of thermal expansion of said heat sink matches the coefficient of thermal expansion of said rotatable disc brake rotor.

5. The improved disc brake in accordance with claim 1 wherein said plurality of heat sinks is fabricated from a group comprising a metal, a metal matrix, a ceramic, a carbon, or a carbon fiber.

6. The improved disc brake in accordance with claim 1 wherein said plurality of heat sinks are pressed or brazed into said disc brake rotor.

7. A heat sink for a disc brake for improved heat dissipation and cooling of said disc brake, said disc brake comprising a rotatable disc brake rotor having a hub for mounting, and an annular contact surface area about said hub, said annular contact surface area having a first side and a second side, said annular contact surface area passing through a pneumatically activated brake shoe for frictionally engaging said annular contact surface area for the slowing or stopping of rotation of said disc brake rotor, said heat sink comprising:
a tubular member having inwardly spaced apart radial fins, said heat sink being pressed or brazed into a plurality of apertures formed in said rotatable disc brake rotor, said heat sinks increasing the surface area of said disc brake rotor for improved heat dissipation and cooling.

8. The heat sink in accordance with claim 7 wherein said heat sink is formed from a material having a coefficient of thermal expansion matching the coefficient of thermal expansion of said disc brake rotor.

9. The heat sink in accordance with claim 7 wherein said heat sink is fabricated from a group comprising a metal, a metal matrix, a ceramic, a carbon, or a carbon fiber.

10. The heat sink in accordance with claim 7 wherein said apertures for receipt of said heat sink are formed between said first surface and said second surface of said disc brake rotor in said annular contact surface area.

11. The heat sink in accordance with claim 7 wherein said apertures for receipt of said heat sink are formed in the circumferential periphery between said first side and said second side of said disc brake rotor, and are oriented either axially or obliquely with said hub.
